(19) United States
(12) Patent Application Publication
(10) Pub. No.: US 2010/0303194 A1
(43) Pub. Date: Dec. 2, 2010

(54) NUCLEAR FUEL ARRANGEMENT IN FUEL POOLS FOR NUCLEAR POWER PLANT

(75) Inventors: JAU-TYNE YEH, Taoyuan County (TW); TA-LUN SUNG, Taoyuan County (TW); CHUNG-HSING HU, Taoyuan County (TW); SHYUN-JUNG YAUR, Taoyuan County (TW)

Correspondence Address: WPAT, PC;INTELLECTUAL PROPERTY ATTORNEYS, 7225 BEVERLY ST., ANNANDALE, VA, 22003, US

(73) Assignee: Institute of Nuclear Energy Research Atomic Energy Council, Executive Yuan, Taoyuan County (TW)

(21) Appl. No.: 12/560,486

(22) Filed: Sep. 16, 2009

(30) Foreign Application Priority Data
May 27, 2009 (TW) 098117678

(51) Int. Cl. G21C 3/34

(52) U.S. Cl. 376/438

(57) ABSTRACT

A nuclear fuel arrangement in fuel pools for nuclear power plant is disclosed, which comprises: a plurality of nuclear fuel bundles, being arranged in a tight formation; a pool partition framework, formed with a plurality of grids for storing the plural nuclear fuel bundles; wherein the partition frame has a plurality of blocks of different heights disposed at the bottoms of their corresponding grids to be used for enabling any neighboring nuclear fuel bundles in the tight formation to be ruggedly arranged with different heights.

### FIELD OF THE INVENTION

The present invention relates to a nuclear fuel arrangement in fuel pools for nuclear power plant, and more particularly, to a fuel arrangement for a fuel pool capable of arranging nuclear fuel bundles in a rugged formation of different heights for reducing flux and effective multiplication factor of neutrons and thus causing the nuclear critical safety of the fuel pool to be enhanced

### BACKGROUND OF THE INVENTION

The production of greenhouse gases and potential climate change is a problem of global proportion. Man's use of energy, especially in industrial activity with fossil fuel burning that emits gases containing carbon dioxide, is thought by most experts to be the major contributor to greenhouse effect responsible for climate change. Thus, people all over the world are searching for alternative energies as they are aiming to live in a greener and more energy efficient lives. Among those available alternative energies, as nuclear power can provide energy in a manner which contributes very little to the greenhouse effect, it will necessarily play a greater role in our lives in the future. However, there are still many details and operations in the nuclear power generation required to be improved for safety.

Normally, in most nuclear power plants, the fuel bundles as well as the spent fuel bundles are stored in fuel pools whereas the arrangement of the fuel bundles in the fuel pools is regulated for preventing those fuel bundle from being placed too close to each other and thus causing critical safety problem. However, for increasing the amount of fuel bundles capable of being stored in a fuel pool while preventing the critical safety problem from happening as the distance between any two neighboring fuel bundles may be too close, boron pieces or other neutron-absorbing materials are used in the fuel pool for reducing the flux of neutrons. Alternatively, the flux of neutrons can be reduced by arranging the fuel bundles in the fuel pools at positions according to their extents of burn-up. However, the use of boron piece will increase cost and the position arrangement/adjustment may be erroneous by human error, that both methods for increasing the amount of fuel bundles capable of being stored in a fuel pool still have shortcomings require to be improved.

For improving nuclear safety, the design of the aforesaid nuclear fuel arrangement must take the critical safety problem relating to neutrons in nuclear fuel as well as heat dissipating problem into consideration. That is, the nuclear fuel arrangement should be designed for arranging the fuel bundles in a formation conforming to international regulations. Please refer to FIG. 1 and FIG. 2, which are schematic diagrams showing respectively a conventional fuel bundle and a plurality of fuel bundles in a conventional formation as they are stored according to a conventional nuclear fuel arrangement. As shown in FIG. 1 and FIG. 2, by lining up the plural fuel bundles 11 in a neat formation 2, the group of the plural fuel bundles 11 can be fitted and stored easily inside a fuel pool. However, such neat formation 2 may not be the optimal formation regarding to nuclear fuel storage safety that should be improved.

### SUMMARY OF THE INVENTION

In view of the disadvantages of prior art, the object of the present invention is to provide a nuclear fuel arrangement in fuel pools for nuclear power plant capable of arranging the nuclear fuel bundles in the fuel pools in an improved formation for narrowing the distances between any two nuclear fuel bundles in the formation while meeting the optical safety requirement. In an embodiment, the present invention provides a nuclear fuel arrangement capable of arranging the nuclear fuel bundles in a rugged formation of different heights for reducing flux and effective multiplication factor of neutrons and thus causing the nuclear critical safety of the dry storage canister to be enhanced.

To achieve the above object, the present invention provides a nuclear fuel arrangement in fuel pools for nuclear power plant, which comprises: a plurality of nuclear fuel bundles, being arranged in a tight formation; a pool partition framework, formed with a plurality of grids for storing the plural nuclear fuel bundles; wherein the pool partition frame has a plurality of blocks of different heights disposed at the bottoms of their corresponding grids to be used for enabling any neighboring nuclear fuel bundles in the tight formation to be ruggedly arranged with different heights.

Preferably, the blocks in the odd-numbered rows or columns of the pool partition framework are formed of a same specific height for aligning the nuclear fuel bundles in the odd-numbered rows or columns to each other at the same height while the blocks in the even-numbered rows or columns of the pool partition framework are formed of another same specific height for aligning the nuclear fuel bundles in the even-numbered rows or columns to each other at the same height.

Preferably, the plural blocks are substantially a grouping of high blocks and low blocks arranged in a chessboard-like array in a manner that any one high block is surrounded by low blocks and any one low block is surrounded by high blocks.

Preferably, the height difference between neighboring nuclear fuel bundles is ranged between 3 inches to 12 inches.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram showing a conventional nuclear fuel bundle.

FIG. 2 is a schematic diagram showing a plurality of nuclear fuel bundles in a conventional formation for storage.

FIG. 3 shows how the plural fuel bundles can be arranged ruggedly with different heights in a nuclear fuel arrangement in fuel pools for nuclear power plant of the invention.

FIG. 4 is a three-dimensional diagram showing a pool partition framework of the present invention.

FIG. 5 is a schematic diagram showing how the plural nuclear fuel bundles can be received inside a pool partition framework of the present invention.

FIG. 6 is a schematic diagram showing how blocks are disposed on the bottom of a pool partition framework according to a first embodiment of the invention.

FIG. 7 is a schematic diagram showing how blocks are disposed on the bottom of a pool partition framework according to a second embodiment of the invention.

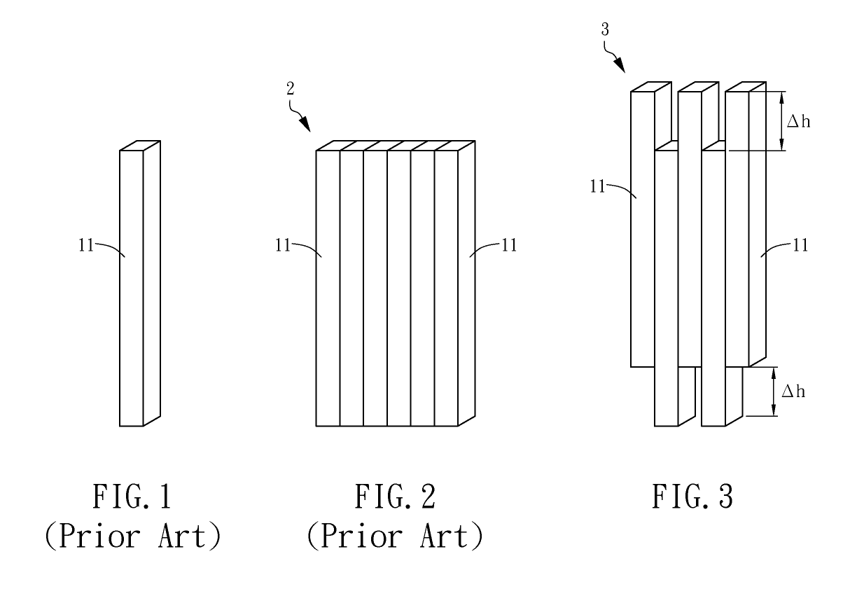

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

Please refer to FIG. 3, which shows how the plural fuel bundles can be arranged ruggedly with different heights in a nuclear fuel arrangement in fuel pools for nuclear power plant of the invention. In FIG. 3, there is a plurality of nuclear fuel bundles 11 being lined up in a rugged formation 3 with a height difference Δh ranged between 3 inches to 12 inches. It is noted that when the height difference Δh is too large, the rugged formation 3 of the plural nuclear fuel bundles may not be received inside a pool partition framework in the fuel pool easily and thus a larger pool partition framework may be required; on the other hand, when the height difference Δh is too small, the requirement matching nuclear critical safety may not be achieved.

The following description is related to critical condition in neutron behavior for illustrating the aforesaid rugged formation 3 with height difference Δh can achieve higher nuclear critical safety. The effective multiplication factor (k_{eff}), which is defined as the ratio of the neutrons produced by fission in one generation to the number of neutrons in the preceding generation. So, the value of k_{eff} for a self-sustaining chain reaction of fissions, where the neutron population is neither increasing nor decreasing, is one. The condition where the neutron chain reaction is self-sustaining and the neutron population is neither increasing nor decreasing is referred to as the critical condition and can be expressed by the simple equation k_{eff}=1. On the other hand, when k_{eff}<1, it is referred as subcritical condition whereas flux decreases each generation; and when k_{eff}>1, it is referred as supercritical condition whereas the neutron flux increases each generation indicating that the nuclear reaction might not be able to stop. Therefore, for achieving nuclear safety, the value of k_{eff} should be restricted. Moreover, as k_{eff} is closely related to the density of neutrons being produced in the fission, the arranging of the fuel bundle in the rugged formation of height difference is able to cause the density of neutrons distributed on the top and bottom of the storage canister to drop and thus cause the value of k_{eff} to reduce so as to enhance the nuclear safety.

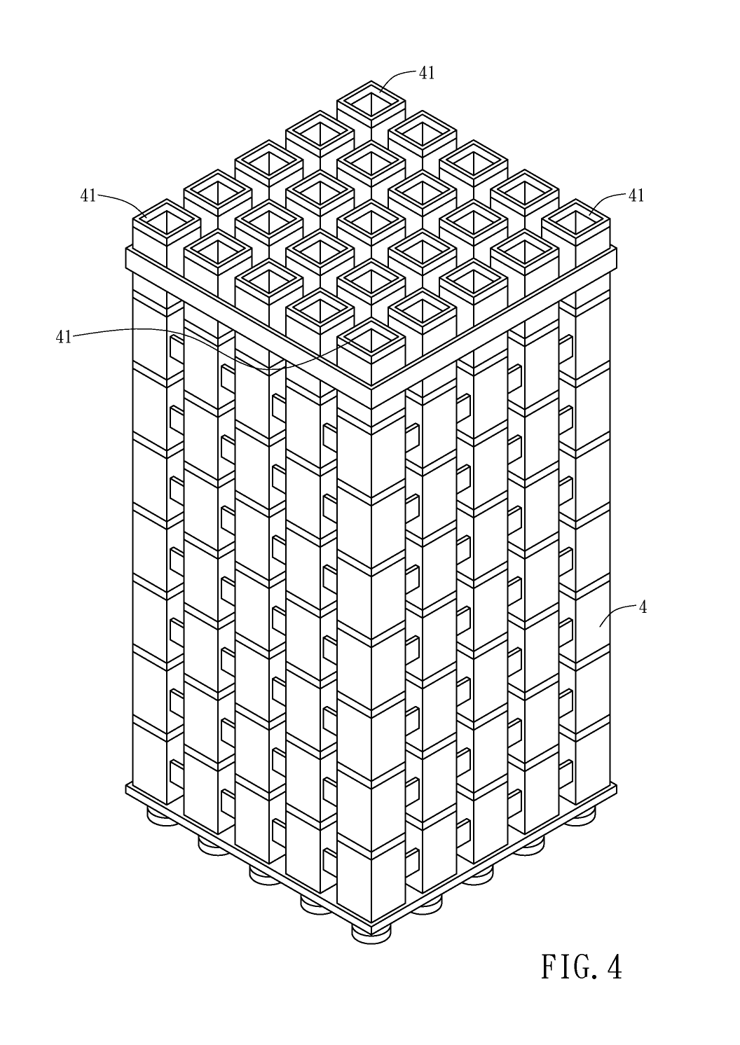

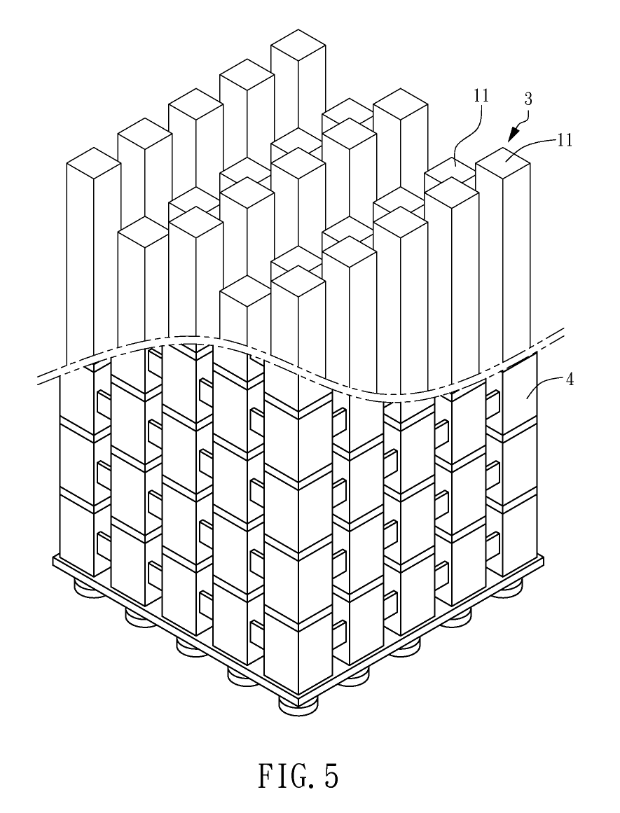

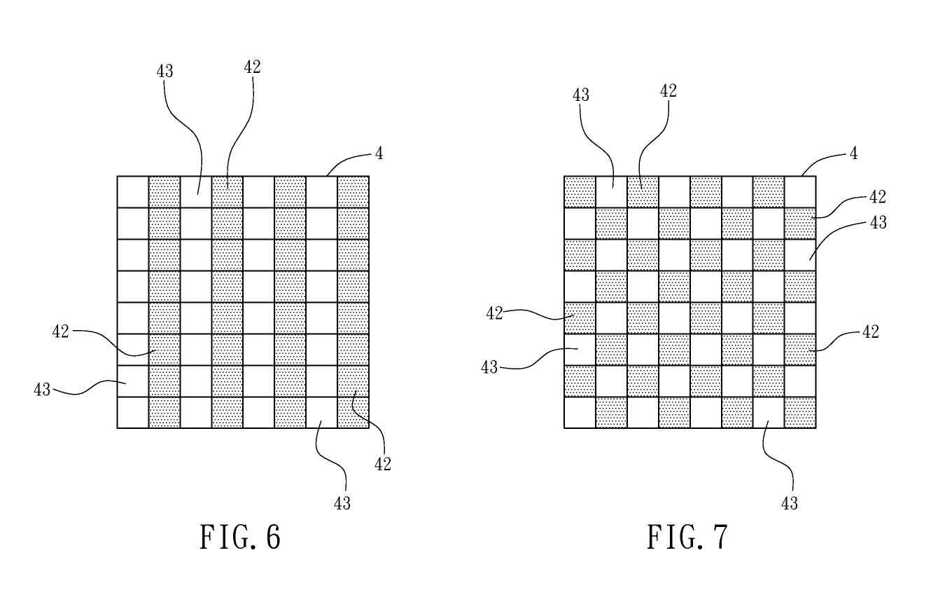

Please refer to FIG. 4 and FIG. 5, which are schematic diagrams showing a three-dimensional view of a pool partition framework and how the plural nuclear fuel bundles can be received inside a pool partition framework of the present invention. In FIG. 4, the pool partition framework 4 is formed with a plurality of grids 41 for storing the plural nuclear fuel bundles 11. There is a plurality of blocks of different heights, such as the high blocks 42 and low blocks 43 shown in FIG. 6, being disposed at the bottoms of their corresponding grids 41 that each of the blocks are provided for one of the plural nuclear fuel bundles 11 to mounted fixedly thereon for enabling any neighboring nuclear fuel bundles 11 in the tight formation to be ruggedly arranged with different heights, i.e. as the rugged formation 3 shown in FIG. 3. In an embodiment of the invention, the blocks in the odd-numbered rows or columns of the pool partition framework 4 are formed of a same specific height for aligning the nuclear fuel bundles 11 in the odd-numbered rows or columns to each other at the same height while the blocks in the even-numbered rows or columns of the pool partition framework 4 are formed of another same specific height for aligning the nuclear fuel bundles 11 in the even-numbered rows or columns to each other at the same height; and the height difference between neighboring nuclear fuel bundles is ranged between 3 inches to 12 inches. In addition, the pool partition framework 4 is made of a metal. For conforming to regulations and safety requirements, the distances between neighboring nuclear fuel bundles 11 should be maintained in the rugged formation 3 for preventing the critical safety problem relating to neutrons in spent nuclear fuel as well as heat dissipating problem from happening

Please refer to FIG. 6 and FIG. 7, which are schematic diagrams showing how blocks are formed on the bottom in pool partition framework according to two different embodiments of the invention. As shown in FIG. 6 and FIG. 7, both the blocks formed on the bottom of the pool partition framework 4 are substantially a grouping of high blocks 42 and low blocks 43 arranged alternatively in an array of various shapes. The blocks of FIG. 6 is arranged in an array similar to those shown in FIG. 5, but it is structured for enabling the blocks in the odd-numbered rows or columns of the pool partition framework 4 to be high blocks 42 while enabling those in the even-numbered rows or columns of the pool partition framework 4 to be low blocks 43. In FIG. 7, the high blocks 42 and low blocks 43 are structured and arranged in a chessboard-like array in a manner that any one high block 42 is surrounded by low blocks 43 and any one low block 43 is surrounded by high blocks 42. It is noted that the storage safety using the configuration shown in FIG. 7 is higher than that of FIG. 6.

From the embodiments disclosed in FIG. 3˜FIG. 7, it is noted that the present invention provides a dry storage canister capable of arranging the nuclear fuel bundles stored therein in a rugged formation of different heights for reducing flux and effective multiplication factor of neutrons and thus causing the nuclear critical safety of the dry storage canister to be enhanced.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A nuclear fuel arrangement in fuel pools for nuclear power plant, comprising:
a plurality of nuclear fuel bundles, being arranged in a tight formation; and
a pool partition framework, formed with a plurality of grids for storing the plural nuclear fuel bundles;
wherein the pool partition frame has a plurality of blocks of different heights disposed at the bottoms of their corresponding grids to be used for enabling any neighboring nuclear fuel bundles in the tight formation to be ruggedly arranged with different heights.

2. The nuclear fuel arrangement of claim 1, wherein the blocks in the odd-numbered rows or columns of the pool partition framework are formed of a same specific height for aligning the nuclear fuel bundles in the odd-numbered rows or columns to each other at the same height while the blocks in the even-numbered rows or columns of the pool partition framework are formed of another same specific height for aligning the nuclear fuel bundles in the even-numbered rows or columns to each other at the same height.

3. The nuclear fuel arrangement of claim 1, wherein the plural blocks are substantially a grouping of high blocks and low blocks arranged in a chessboard-like array in a manner that any one high block is surrounded by low blocks and any one low block is surrounded by high blocks.

4. The nuclear fuel arrangement of claim 1, wherein the height difference between neighboring nuclear fuel bundles is ranged between 3 inches to 12 inches.

5. The nuclear fuel arrangement of claim 1, wherein the pool partition framework is made of a metal.

6. The nuclear fuel arrangement of claim 1, wherein each of the plural nuclear fuel bundle is a fuel bundle selected from the group consisting of: a spent nuclear fuel bundle and an unused nuclear fuel bundle.
